(19) United States
(12) Patent Application Publication
(10) Pub. No.: US 2020/0186484 A1
(43) Pub. Date: Jun. 11, 2020

(54) METHOD AND APPARATUS FOR PROCESSING IMAGE IN APPLICATION, TERMINAL DEVICE AND STORAGE MEDIUM

(71) Applicant: Tencent Technology (Shenzhen) Company Limited, Shenzhen (CN)

(72) Inventors: Xiaoming Yang, Shenzhen (CN); Shaofeng Li, Shenzhen (CN); Minghao Zhu, Shenzhen (CN)

(21) Appl. No.: 16/794,001

(22) Filed: Feb. 18, 2020

Related U.S. Application Data
(63) Continuation of application No. PCT/CN2018/103874, filed on Sep. 4, 2018.

(30) Foreign Application Priority Data
Sep. 7, 2017 (CN) 201710811389.1

(51) Int. Cl. H04L 12/58; G06K 9/00

(52) U.S. Cl. CPC H04L 51/10; G06K 9/00302; H04L 51/046; H04L 51/32

(57) ABSTRACT

Provided is a method for processing an image in a social networking application, performed by a terminal device. The method includes: receiving an expression file generating instruction corresponding to an image displayed in the social networking application; invoking an expression editing tool built in the application according to the expression file generating instruction obtained after the image is triggered; obtaining a self-made expression image corresponding to the image by using the expression editing tool and an expression editing operation triggered for the image; and generating a self-made expression file that is configured in the social networking application and that corresponds to the self-made expression image, the self-made expression file being invoked by the social networking application to implement a self-configured specified function of the social networking application, and the specified function being different from an expression making function.

### CROSS-REFERENCE TO RELATED APPLICATIONS

This application is a continuation application of PCT/CN2018/103874, entitled “METHOD AND APPARATUS FOR PROCESSING IMAGE IN APPLICATION, TERMINAL DEVICE, AND STORAGE MEDIUM” filed on Sep. 4, 2018, which claims priority to Patent Application No. 201710811389.1, entitled “METHOD AND APPARATUS FOR PROCESSING IMAGE IN APPLICATION, TERMINAL DEVICE, AND STORAGE MEDIUM” and filed on Sep. 7, 2017, all of which are incorporated by reference in their entirety.

### FIELD OF THE TECHNOLOGY

The present disclosure relates to the field of computer application technologies, and in particular, to a method and an apparatus for processing an image in an application, a terminal device, and a storage medium.

### BACKGROUND OF THE DISCLOSURE

An expression image plays a very important role in Internet life. The expression image is different from a word, and implements transmission of information in various scenarios. For example, the information may be information transmitted by using the expression image as major content in a social networking application, information released by using the expression image as a part of content in a network application, or the like.

The expression image exists in a form of an expression file, and content displayed by the expression file is the expression image. The expression file is obtained by obtaining and saving an expression image through image editing by using a meme making application. After obtaining the expression file, a user can only jump to another application to transmit the expression image corresponding to the expression file. For example, after the made expression image is saved to obtain the expression file, the user jumps to an application in which the expression image is to be used, such as a social networking application or a network application, and then the expression image corresponding to the expression file is transmitted through an operation of adding a meme.

Because the image to be edited by the meme making application is obtained by using the application in which the expression image is to be used, the image needs to be exported from the application and then loaded in the meme making application.

The entire process is complex, and a specific meme making application is required additionally. For the application in which the expression image is to be used, many complex operations are required, and the corresponding expression file cannot be quickly configured.

### SUMMARY

The present disclosure provides a method and an apparatus for processing an image in an application, a terminal device, and a storage medium.

A method for processing an image in a social networking application is performed by a terminal device, and the method includes:

receiving an expression file generating instruction corresponding to an image displayed in an interface of the social networking application run by the terminal device;

invoking an expression editing tool built in the social networking application according to the expression file generating instruction obtained after the image is triggered;

obtaining a self-made expression image corresponding to the image by using the expression editing tool and an expression editing operation triggered for the image; and

generating, in the interface of the social networking application, a self-made expression file that is configured in the social networking application and that corresponds to the self-made expression image, the self-made expression file being invoked by the social networking application to implement a self-configured specified function of the social networking application, and the specified function being different from an expression making function.

A terminal device for processing an image in a social networking application comprises one or more processors, memory coupled to the one or more processors and a plurality of programs stored in the memory that, when executed by the one or more processors, cause the terminal device to perform the aforementioned image processing method.

A non-transitory computer-readable storage medium stores a plurality of machine readable instructions in connection with a terminal device having one or more processors for processing an image in a social networking application, wherein the plurality of machine readable instructions, when executed by the one or more processors, cause the terminal device to perform the aforementioned image processing method.

It can be understood that the above general descriptions and the following detailed descriptions are merely exemplary, and cannot limit the present disclosure.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of an implementation environment according to an exemplary embodiment.

FIG. 2 is a block diagram of an apparatus according to an exemplary embodiment.

FIG. 3 is a flowchart of a method for processing an image in an application according to an exemplary embodiment.

FIG. 4 is a flowchart for describing details of step S350 according to the embodiment corresponding to FIG. 3.

FIG. 5 is a flowchart for describing details of step S370 according to the embodiment corresponding to FIG. 3.

FIG. 6 is a flowchart of a method for processing an image in an application according to another exemplary embodiment.

FIG. 7 is a schematic diagram of an interface of a session window between a user and a friend in an instant messaging tool according to an exemplary embodiment.

FIG. 8 is a schematic diagram of an interface of a session window in which action items pop up according to the embodiment corresponding to FIG. 7.

FIG. 9 is a schematic diagram of an expression editing interface for cropping an image according to the embodiment corresponding to FIG. 8.

FIG. 10 is a schematic diagram of an interface in which text input is triggered in a cropped image according to the embodiment corresponding to FIG. 9.

FIG. 11 is a schematic diagram of an interface in which text has been inputted according to the embodiment corresponding to FIG. 10.

FIG. 12 is a schematic diagram of an interface in which inputted text has been rendered according to the embodiment corresponding to FIG. 11.

FIG. 13 is a schematic diagram of a session window in which a self-made expression image is transmitted according to the embodiment corresponding to FIG. 12.

FIG. 14 is a schematic diagram of displaying a self-made expression file in a thumbnail view in a session window according to the embodiment corresponding to FIG. 13.

FIG. 15 is a schematic flowchart of implementing a self-made expression image in an instant messaging tool according to an exemplary embodiment.

FIG. 16 is a block diagram of an apparatus for processing an image in an application according to an exemplary embodiment.

FIG. 17 is a block diagram for describing details of a self-made expression obtainer according to the embodiment corresponding to FIG. 16.

FIG. 18 is a block diagram for describing details of a configurator according to the embodiment corresponding to FIG. 16.

FIG. 19 is a block diagram of an apparatus for processing an image in an application according to another exemplary embodiment.

### DESCRIPTION OF EMBODIMENTS

Exemplary embodiments are described in detail herein, and examples of the exemplary embodiments are shown in the accompanying drawings. When the following descriptions relate to the accompanying drawings, unless otherwise indicated, same numbers in different accompanying drawings represent same or similar elements. The implementations described in the following exemplary embodiments do not represent all implementations consistent with the present disclosure. On the contrary, the implementations are merely examples of apparatuses and methods that are described in detail in the appended claims and that are consistent with some aspects of the present disclosure.

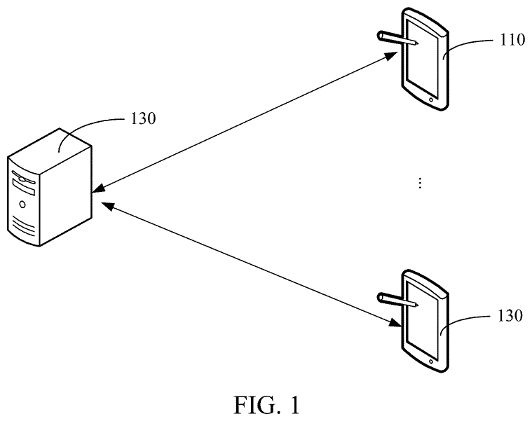

In an exemplary embodiment, as shown in FIG. 1, an implementation environment in the present disclosure includes at least a terminal device 110 used by a user and an application server 130 cooperating with an application in the terminal device 110.

The terminal device 110 may be a desktop computer, a notebook computer, a smartphone, a tablet computer, or the like. The application run by the terminal device 110 cooperates with the corresponding application server to implement a specified function that is deployed. Before the specified function is implemented, an expression file making process of a displayed image is performed in the application, to configure an expression file that is made by a user for the application.

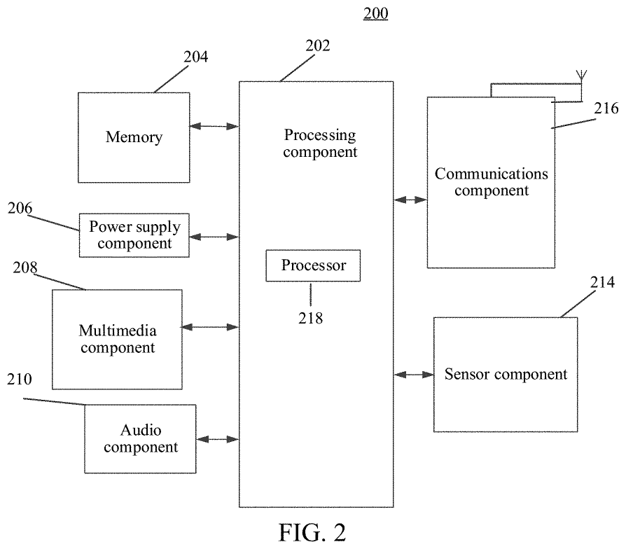

FIG. 2 is a block diagram of an apparatus according to an exemplary embodiment. For example, an apparatus 200 may be a terminal device in an implementation environment shown in FIG. 2.

Referring to FIG. 2, the apparatus 200 may include one or more of the following components: a processing component 202, a memory 204, a power supply component 206, a multimedia component 208, an audio component 210, a sensor component 214, and a communications component 216.

The processing component 202 generally controls overall operations of the apparatus 200, such as operations related to displaying, a phone call, data communication, a camera operation, and a record operation. The processing component 202 may include one or more processors 218 to execute instructions, to implement all or some steps of the following method. In addition, the processing component 202 may include one or more modules, to facilitate the interaction between the processing component 202 and other components. For example, the processing component 202 may include a multimedia module, to facilitate the interaction between the multimedia component 208 and the processing component 202.

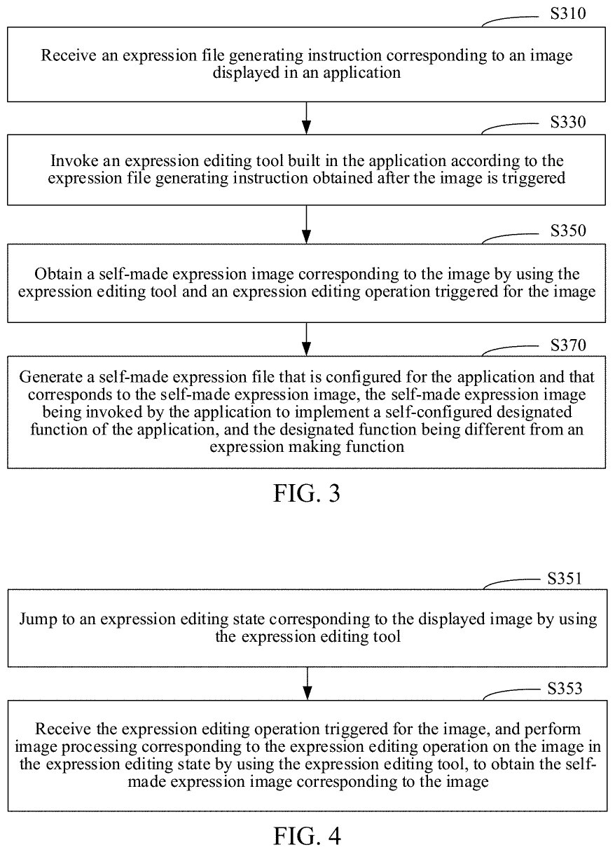

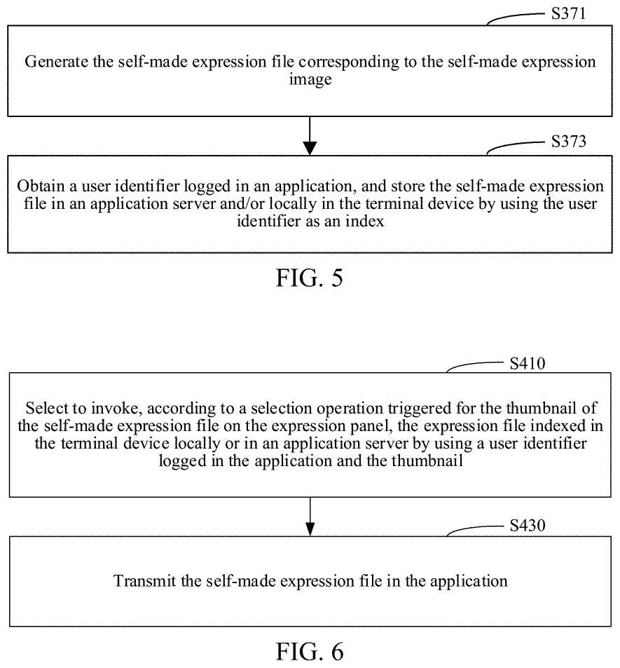

The memory 204 is configured to store various types of data to support operations on the apparatus 200. Examples of the data include instructions of any application program or method that are configured to be operated on the apparatus 200. The memory 204 may be implemented by using a volatile or non-volatile storage device of any type or a combination thereof, for example, a static random access memory (SRAM), an electrically erasable programmable read-only memory (EEPROM), an erasable programmable read only memory (EPROM), a programmable read-only memory (PROM), a read-only memory (ROM), a magnetic memory, a flash memory, a magnetic disk, or an optical disc. The memory 204 further stores one or more modules, and the one or more modules are configured to be executed by the one or more processors 218, to implement all or some steps of the following method shown in any of FIG. 3, FIG. 4, FIG. 5, and FIG. 6.

The power supply component 206 provides power to various components of the apparatus 200. The power supply component 206 may include a power supply management system, one or more power supplies, and other components associated with generating, managing and allocating power for the apparatus 200.

The multimedia component 208 includes a screen providing an output interface between the apparatus 200 and a user. In some embodiments, the screen may include a liquid crystal display (LCD) and a touch panel. If the screen includes the touch panel, the screen may be implemented as a touchscreen to receive an input signal from the user. The touch panel includes one or more touch sensors to sense a touch, a slide, and a gesture on the touch panel. The touch sensor may not only sense the boundary of touching or sliding operations, but also detect duration and pressure related to the touching or sliding operations. The screen may further include an organic light emitting display (OLED).

The audio component 210 is configured to output and/or input an audio signal. For example, the audio component 210 includes a microphone (MIC). When the apparatus 200 is in an operating mode, such as a call mode, a record mode, and a speech recognition mode, the MIC is configured to receive an external audio signal. The received audio signal may be further stored in the memory 204 or transmitted through the communications component 216. In some embodiments, the audio component 210 further includes a loudspeaker, configured to output an audio signal.

The sensor component 214 includes one or more sensors, configured to provide state evaluation in each aspect to the apparatus 200. For example, the sensor component 214 may detect a power-on/off state of the apparatus 200 and a relative location of a component. The sensor component 214 may further detect a location change of the apparatus 200 or a component of the apparatus 200 and a temperature change of the apparatus 200. In some embodiments, the sensor component 214 may further include a magnetic sensor, a pressure sensor, or a temperature sensor.

The communications component 216 is configured to facilitate communication in a wired or wireless manner between the apparatus 200 and other devices. The apparatus 200 may access a communication standard-based wireless network, such as Wireless Fidelity (Wi-Fi). In an exemplary embodiment, the communications component 216 receives a broadcast signal or broadcast related information from an external broadcast management system through a broadcast channel. In an exemplary embodiment, the communications component 216 further includes a near field communication (NFC) module to facilitate short-distance communication. For example, the NFC module may be implemented based on a radio frequency identification (RFID) technology, an Infrared Data Association (IrDA) technology, an ultra-wideband (UWB) technology, a Bluetooth technology, and other technologies.

In an exemplary embodiment, the apparatus 200 may be implemented by using one or more application-specific integrated circuits (ASICs), a digital signal processor, a digital signal processing device, a programmable logic device, a field programmable gate array, a controller, a micro controller, a microprocessor, or other electronic elements, and is configured to perform the following method.

FIG. 3 is a flowchart of a method for processing an image in an application according to an exemplary embodiment. The method for processing an image in an application is applicable to a terminal device in the foregoing implementation environment. In an exemplary embodiment, the terminal device may be the apparatus shown in FIG. 2. As shown in FIG. 3, the method for processing an image in an application may be performed by the terminal device and may include the following steps.

Step S310. Receive an expression file generating instruction corresponding to an image displayed in an application.

The image displayed in the application refers to any image that is displayed in an application interface. The image includes various dynamic images and static images. The application is any application program that displays an image and implements a specified function by using an expression file. The application includes a social networking application, various network applications for presenting network information, and the like. For example, the application may be an instant messaging tool, Weibo, or the like. A specified function of the instant messaging tool is a session function, while a specified function of Weibo may be a function of releasing a message including an expression image.

The expression file generating instruction corresponding to the image displayed in the application is generated by triggering the image displayed in the application interface. The image is displayed in the application interface of the application. In this case, the expression file generating instruction may be triggered for the image.

Specifically, in the application interface, as the image is displayed, the displayed image may be triggered. For example, in a specific implementation of an exemplary embodiment, for a user, the user triggers operations such as a tap or touch-and-hold on the image, and then related action items of the image may be activated. The related action items include an expression making action item and other action items. After the user selects the expression making action item, the expression file generating instruction triggered for the displayed image may be generated. Correspondingly, the application monitors whether a tap or touch-and-hold operation is triggered in the process of displaying the image. If the tap or touch-and-hold operation is triggered on the application interface, and the triggered tap or touch-and-hold operation is positioned to the displayed image, an interface function is invoked in response to the tap or touch-and-hold operation triggered on the displayed image, to generate the expression file generating instruction. Therefore, in the implementation of the present disclosure, the expression file generating instruction transmitted by the interface function may be received.

In another exemplary embodiment, the image displayed by the application may be a dynamic image. Therefore, for the user, the dynamic image displayed in the application may be captured according to a requirement of a self-made expression image need by the user, to obtain one frame image, and the expression file generating instruction is generated for the frame image.

There are one or two or more images displayed in the application. Correspondingly, an object on which the process of receiving the corresponding expression file generating instruction to obtain the expression image is performed may be one of the displayed images. Alternatively, expression making may be implemented in batch for two or more images. This is not limited herein.

In an exemplary embodiment, the application is a social networking application, and the image is an image received or transmitted in a session of the social networking application. Step S310 specifically includes:

receiving the expression file generating instruction corresponding to the image displayed in the social networking application in a session interface, of the social networking application, displaying the received and/or transmitted image, the self-made expression file generated by the expression file generating instruction for the displayed image being invoked by the social networking application to implement a function of transmitting an expression image in the session.

The social networking application is used for implementing a session between a user that is logged in and other users. The session includes a one-to-one session between users, for example, a session between a user and a friend of the user, and also includes a group session between users.

A corresponding session window implements a session interface. During the session, messages are transmitted and received. In the transmitted or received messages, a carried image and words are simultaneously displayed in the session interface. In this way, the image displayed in the application is obtained. A process of obtaining the self-made expression image corresponding to the image, and then generating the self-made expression file may be initiated by triggering the image.

Herein, a configured specified function of the social networking application is a function of transmitting the expression image in the session.

Certainly, in addition to the social networking application, the application may also be a network application, or the like, for example, an expression store application that is loaded by using a browser. Configured specified functions are different according to different applications. A configured specified function of the expression store application is a function of releasing an expression image corresponding an expression file, and authorizing the expression file to a paying user.

Any image displayed in the application may be directly triggered to generate a corresponding self-made expression image and a corresponding self-made expression file, and then finally applied to an application displaying the image. On one hand, immediacy is improved; on the other hand, expression files configured in the application are enriched, so that any image that is obtained by the user by using the application may be configured with a corresponding expression file in the application.

In another exemplary embodiment, step S310 specifically includes: activating related action items of the displayed image in the application or the social networking application, and obtaining the expression file generating instruction corresponding to the displayed image through triggering of selection of an expression making action item in the related action items.

As described above, the application can display the image and needs to implement the function of the application by using the expression image. The application may be a social networking application or any other application listed above.

For the social networking application or any other application, triggering and execution of the process of generating the self-made expression file of the specified image may be implemented through the related action items of the image. The related action items of the image include an expression making action item and other action items. After the related action items of the displayed image are activated, the expression file generating instruction may be obtained through an operation of selecting the expression making action item in the related action items.

It can be understood that, the related action items are configured and activated by using built-in resource files and interface functions. In other words, display formats of the related action items and various action items included in the related action items are all stored as resource files. After a corresponding operation is detected, the related action items may be invoked under the action of the interface function, activated, and displayed in the application interface.

Step S330. Invoke an expression editing tool built in the application according to the expression file generating instruction obtained after the image is triggered.

The expression editing tool is configured to implement instant image processing in the application, to obtain a corresponding expression image. The expression editing tool is implemented by using an image channel in the application, and implements rendering and drawing of an image and a file after controlled by an expression editing operation triggered by a user.

As the expression file generating instruction obtained after the image is triggered in step S310 is received, it is necessary to use the image to obtain an expected expression image. For example, specific text may be added in the image, or a rendering effect of the image may be changed. Therefore, the expression editing tool built in the application may be invoked by using the expression file generating instruction obtained after the image is triggered.

Step S350. Obtain a self-made expression image corresponding to the image by using the expression editing tool and an expression editing operation triggered for the image.

The image that is triggered to generate an expression file may enter an expression editing state under the action of the expression editing tool built in the application. Image processing may be performed according to the expression editing operation triggered by the user. For example, if an operation of inputting text is triggered, text may be newly added in the image. In addition, an operation of dragging the newly added text to adjust a location may be performed, to adjust the location of the newly added text in the image. Alternatively, the inputted text may be rendered as a specified font. After the needed expression editing operation is completed, the self-made expression image corresponding to the image may be obtained.

The self-made expression image is similar to a common expression image, and both of the images describe or supplement content for information in the images. The common expression image is loaded by an application server and is added in the application, or may be added in the application after received. However, the self-made expression image is different, which is customized by using the image displayed in the application.

It can be understood that, the expression editing operation triggered for the image may be triggered once or multiple times. This is not limited herein. There may be one or more types of triggered expression editing operations.

Certainly, expression editing may not be performed on the image, and the image may be directly used as an expression image. In other words, the triggered expression editing operation may be an operation that determines the image as the self-made expression image.

The self-made expression image corresponding to the obtained image refers to an expression image obtained based on the image displayed in the application. Because an image editing process exists, the obtained expression image is customized by the user.

Step S370. Generate a self-made expression file that is configured in the application and that corresponds to the self-made expression image, the self-made expression image being invoked by the application to implement a self-configured specified function of the application, and the specified function being different from an expression making function.

The finally obtained self-made expression image by using the expression editing tool built in the application and the expression editing operation is saved as a form of an expression file, that is, the self-made expression file is generated, and is configured in the application, so that the application may invoke the file at any time. For example, the generated self-made expression image may be in an EIF format. Therefore, a corresponding self-made expression file may be obtained by only converting the obtained self-made expression image into the EIF format and storing the image.

Compared with the existing form of the self-made expression image, the self-made expression file that is generated and that is configured in the application helps to ensure the quality of the displayed image. Specifically, if an expression image is stored and transmitted in a form of an image, the image may be compressed every time the image is stored and transmitted. This may lead to an increasingly poor definition of the expression image, and poor quality of the image. If the expression image exists in a form of the above self-made expression file and the expression image only serves as display content of the self-made expression file, because the image has been compressed in the image editing process, any secondary compression may not be performed in the process of invoking or being invoked when the image is transmitted or saved again.

In the exemplary embodiment of the present disclosure, the image displayed in the application obtains the self-made expression image, and then the self-made expression file is generated by using the self-made expression image and is configured in the application. Therefore, immediacy and customizability of making the expression file in an implementation scenario of the application can be effectively improved. It can be ensured that when immersed in the application, a user may not be interrupted or disturbed by other applications, which helps to improve activeness and dependence of the user in the application.

After configured in the application, the self-made expression file may be invoked immediately to implement a specified function, or may be invoked later. In other words, the specified function implemented by invoking the self-made expression file may be immediate. For example, the self-made expression file is spread after the image generated during a session is edited. Alternatively, the specified function may be a non-immediate pure production requirement, for example, an expression making function provided by an extended toolbar configured in a social networking application.

In the implementation of the exemplary embodiment of the present disclosure in the social networking application, a user can make the received or transmitted picture or video during a session into a self-made expression file, and transmit the file in a current session interface. Therefore, the user does not need to jump to the social networking application from a special expression making application, and perform complex operations such as importing or saving. Materials of the self-made expression file are images currently spread by the user, and the making process takes place completely during the session, which ensures that the user is immersed in the social networking application.

In the exemplary embodiment of the present disclosure, the image displayed in the application may be triggered to make the expression file, and the application performs the self-configured specified function by using the expression file. In this application, the expression file generating instruction corresponding to the displayed image is firstly received, then the expression editing tool built in the application is invoked by using the expression file generating instruction obtained after the image is triggered, and finally the self-made expression image is generated into the self-made expression file configured in the application. The self-made expression file is invoked by the application to implement the self-configured specified function of the application, and the specified function is different from the expression making function. In this way, the entire process of making and configuring the expression file of the image displayed in the application is implemented, and the intervention of the user operation is needed only when the displayed image is triggered to generate the expression file and when expression editing is performed on the image, which avoids complex operations, and enables the making and configuration of the expression file in the application to be easier. In addition, an extra meme making application is not needed, and the configuration of the image displayed in the application to the expression file in the application is extremely simple.

FIG. 4 is a flowchart for describing details of step S350 according to the embodiment corresponding to FIG. 3. As shown in FIG. 4, step S350 may include the following steps.

Step S351. Jump to an expression editing state corresponding to the displayed image by using the expression editing tool.

As described above, the expression editing tool is built in the application, and is implemented by using the image channel deployed by the application, to provide an image processing logic for execution of an expression editing process.

As the expression editing tool in the application is invoked, the displayed image enters the expression editing state. After the image enters the expression editing state, various expression editing operations may be randomly triggered for the image.

The expression editing state corresponding to the displayed image and jumped to by using the expression editing tool may be a state in which the image displayed in the application can be directly edited and in which action items capable of triggering various expression editing operations pop up. A user may trigger the expression editing operations by selecting any action item.

In addition, a manipulation interface corresponding to the expression editing tool may be jumped to in the application, and the image is loaded in the manipulation interface. Therefore, the various expression editing operations may be triggered for the image in the manipulation interface.

Step S353. Receive the expression editing operation triggered for the image, and perform image processing corresponding to the expression editing operation on the image in the expression editing state by using the expression editing tool, to obtain the self-made expression image corresponding to the image.

In the expression editing tool, the execution of the image processing process is implemented by using the deployed image processing logic. The corresponding image processing logic is performed according to the triggered expression editing operation.

FIG. 5 is a flowchart for describing details of step S370 according to the embodiment corresponding to FIG. 3. As shown in FIG. 5, step S370 may include the following steps.

Step S371. Generate the self-made expression file corresponding to the self-made expression image.

After the expression file generating instruction is triggered for the image displayed in the application, expression editing is performed on the image displayed in the application to obtain the expression image, and then the self-made expression file may be generated.

Step S373. Obtain a user identifier logged in an application, and store the self-made expression file in an application server and/or locally in the terminal device by using the user identifier as an index.

A user logs in the application, and the user identifier is uniquely used for marking the user identity in the application. Because the self-made expression file is customized by the user in the application, the user identifier logged in the application is necessarily obtained, and the user identifier is used as an index to store the self-made expression file.

The self-made expression file may be stored in the terminal device locally or in the application server, so that the self-made expression file is stored locally or remotely.

Therefore, it can be known that, correspondingly, when the self-made expression file needs to be invoked, it only needs to perform invoking by using the user identifier that is logged in the application as the index, so as to implement the specified function configured in the application.

In another exemplary embodiment, after step S370, the method for processing an image in an application further includes the following step:

displaying the self-made expression file in a thumbnail view on an expression panel of the application.

The displaying the self-made expression file in a thumbnail view on an expression panel refers to a process of displaying a thumbnail of the self-made expression file on the expression panel of the application, which is used for triggering the selection and invoking of the self-made expression file. As described above, the expression image corresponding to the self-made expression file includes a dynamic image and a static image. For the static image, displaying the self-made expression file in a thumbnail view on an expression panel is displaying a thumbnail of the static image on the expression panel. For the dynamic image, the dynamic image is implemented by using a graphics interchange format (gif) sequence frame. In other words, the dynamic image is formed by a group of continuous image frames. An image frame is extracted as a thumbnail of the dynamic image, and displayed on the expression panel of the application, thereby displaying the dynamic image in a thumbnail view on the expression panel.

In this way, the self-made expression file is displayed in a thumbnail view on the expression panel, so that the self-made expression file can be invoked by triggering the thumbnail displayed on the expression panel. Therefore, the self-made expression file can be generated and the specified function can be implemented in the application directly.

In the exemplary embodiment, the self-made expression file is displayed in a thumbnail view on the expression panel, so that the self-made expression file is similar to other common expression files, and is consistent with the current expression thumbnail logic, which has very high universality.

FIG. 6 is a flowchart of a method for processing an image in an application according to another exemplary embodiment. A thumbnail of a self-made expression file is associated with an expression file, and after the step of displaying the self-made expression file in a thumbnail view on an expression panel of an application, as shown in FIG. 6, the method for processing an image in an application may include the following steps.

Step S410. Select to invoke, according to a selection operation triggered for the thumbnail of the self-made expression file on the expression panel, the expression file indexed in the terminal device locally or in an application server by using a user identifier logged in the application and the thumbnail.

The expression panel is displayed in the application. The expression panel includes a thumbnail of each expression file, that is, thumbnails of common expression files and self-made expression files. In other words, the thumbnail of each expression file is arranged on the expression panel. A user triggers an operation of selecting a thumbnail to index a corresponding expression file from the terminal device locally or from the application server.

The thumbnail is associated with the expression file. Specifically, the thumbnail corresponding to the expression file is associated with the expression file, and the expression file is stored in the terminal device locally or in the application server by using the user identifier as the index.

Therefore, a corresponding expression file may be invoked according to the selected thumbnail and the user identifier logged in the application.

Step S430. Transmit the self-made expression file in the application.

The self-made expression file is transmitted in the application to implement a self-configured specified function of the application. Implementations of transmitting the self-made expression file in the application are different according to different applications. Specifically, the transmitting the self-made expression file in the application may be releasing the expression file to a specified page by the application, or may be transmitting the expression file to an application in which another user logs. There may be some other implementations, and this is not limited herein.

For example, that an expression store application transmits a self-made expression file is to release a self-made expression image corresponding to the self-made expression file to a specified page of the expression store application, so that other users may view the self-made expression image released in the specified page.

For another example, that a social networking application transmits a self-made expression file includes: on one hand, transmitting the expression file to a friend or a group that is in a session; on the other hand, displaying an expression image corresponding to the expression file to a session window corresponding to the session in the application.

It can be understood that, in the social networking application, the expression file is transmitted to the social networking application in which the friend logs, or a social networking application in which each member in the group logs. In the social networking application that receives the expression file, the corresponding expression image is displayed in the session window.

It can be understood that, the expression file is transmitted through forwarding by the application server, that is, a social networking application server of the social networking application.

In the exemplary embodiment, for the application, the self-made expression file can be obtained without specially downloading and deploying a meme making application. Therefore, the expression file may be customized in an easier and more convenient manner, and the user may be quickly immersed in the process of making the expression file, and may immediately configure and spread the expression file.

In the exemplary embodiment of the present disclosure, the expression file can be simultaneously customized and displayed in the session based on the instant messaging interaction between users in the application. On one hand, for a terminal device whose screen size is limited, for example, a smartphone, operation costs are greatly reduced; on the other hand, materials of the self-made expression file are images that are spread by the user, that is, images transmitted or received by the user. The self-made expression file is made completely during the session, to meet requirements of instant messaging and theme customization, and can be transmitted timely and quickly.

In addition, the self-made expression file obtained in the exemplary embodiment of the present disclosure may be spread to other scenarios in a store-and-forward manner, thereby achieving reuse of the self-made expression file.

The method described above is described with reference to a specific application scenario by using implementation of the self-made expression image in an instant messaging tool as an example. The instant messaging tool runs in a smartphone held by a user.

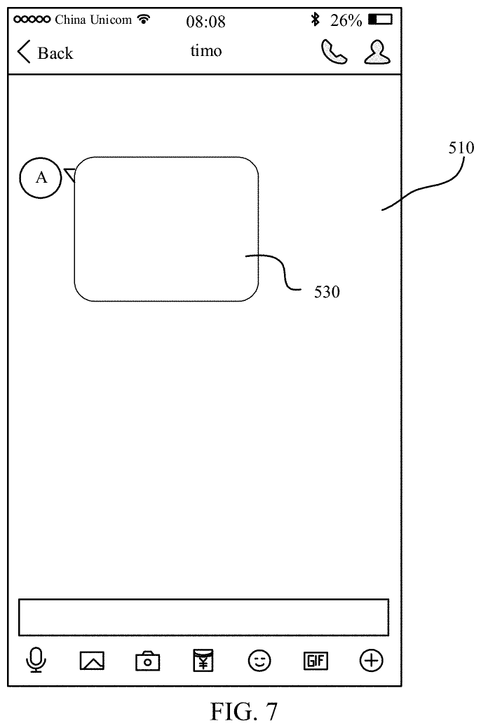

Specifically, the user opens the instant messaging tool in the smartphone, selects a single friend or a group, and enters a corresponding session window. During the session, an operation of transmitting an image is performed, or an image transmitted by the friend or other friends in the group is received. FIG. 7 is a schematic diagram of an interface of a session window between a user and a friend in an instant messaging tool according to an exemplary embodiment.

In a session window 510 between the user and the friend, after messages transmitted by the friend are received, an image 530 transmitted by the friend is displayed in the session window 510.

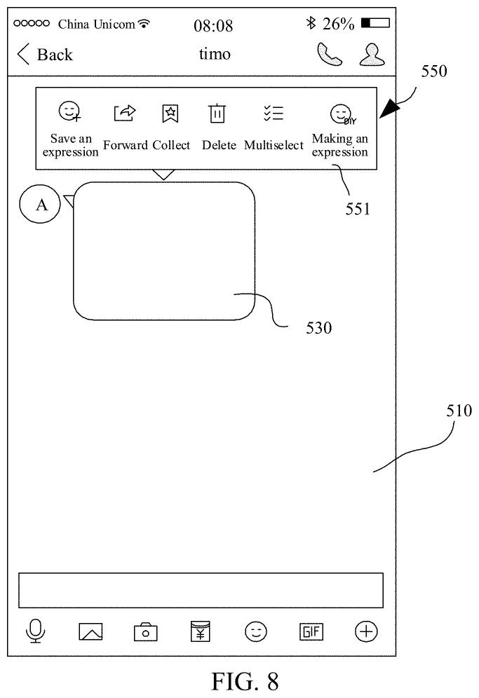

In the session window 510, the user performs touch-and-hold on the image 530 so that action items 550 pop up, and triggers an operation of selecting an expression making action item 551 in the action items 550. In this case, an expression editing interface of the image 530 may be entered. FIG. 8 is a schematic diagram of an interface of a session window in which action items pop up according to the embodiment corresponding to FIG. 7.

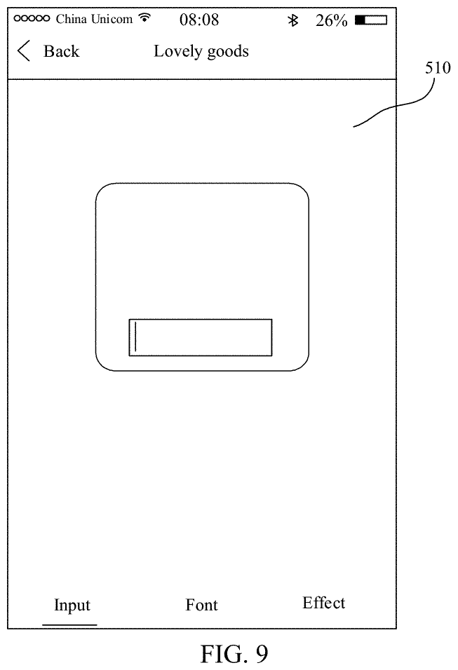

After the expression editing interface of the image 530 is entered, the image 530 is firstly cropped. As shown in FIG. 9, the image 530 is cropped to an image whose size and shape match an expression image, and a specific range of the image is selected. FIG. 9 is a schematic diagram of an expression editing interface for cropping an image according to the embodiment corresponding to FIG. 8.

Then an operation of inputting text is performed. The user may select default text, or may input customized edited text. The inputted text may be dragged to adjust a location. After inputted, the text may be rendered as a preset font. A logo may be automatically added on a corner of the image, so that the expression image is initially obtained.

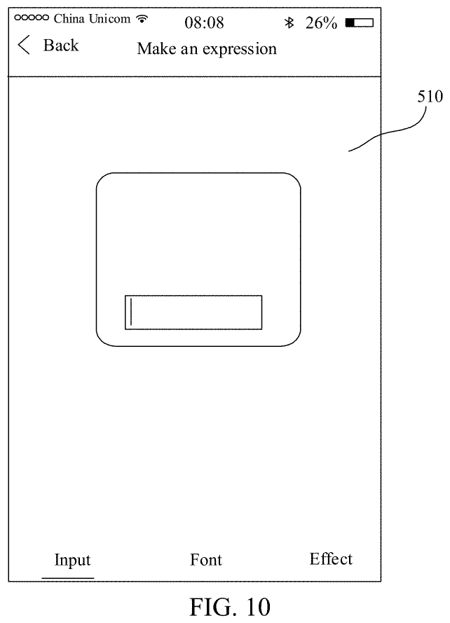

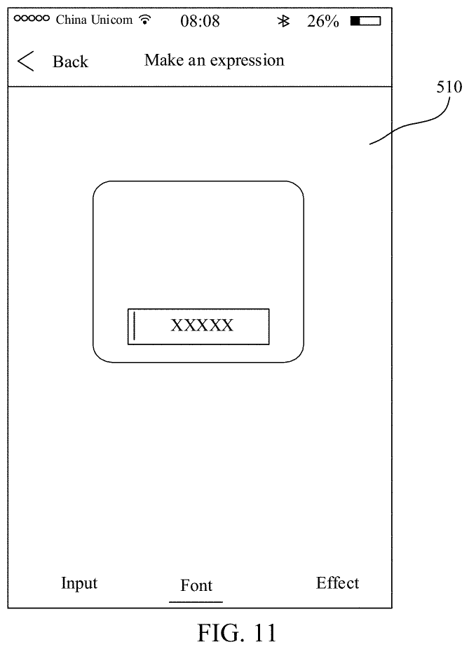

FIG. 10 is a schematic diagram of an interface in which text input is triggered in a cropped image according to the embodiment corresponding to FIG. 9. Correspondingly, FIG. 11 is a schematic diagram of an interface in which text has been inputted according to the embodiment corresponding to FIG. 10.

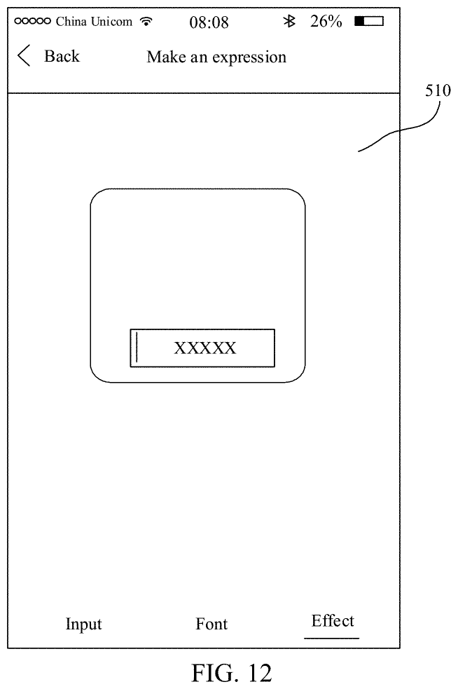

FIG. 12 is a schematic diagram of an interface in which inputted text has been rendered according to the embodiment corresponding to FIG. 11. Therefore, the self-made expression image may be finally obtained through the operations shown in FIG. 10 to FIG. 12.

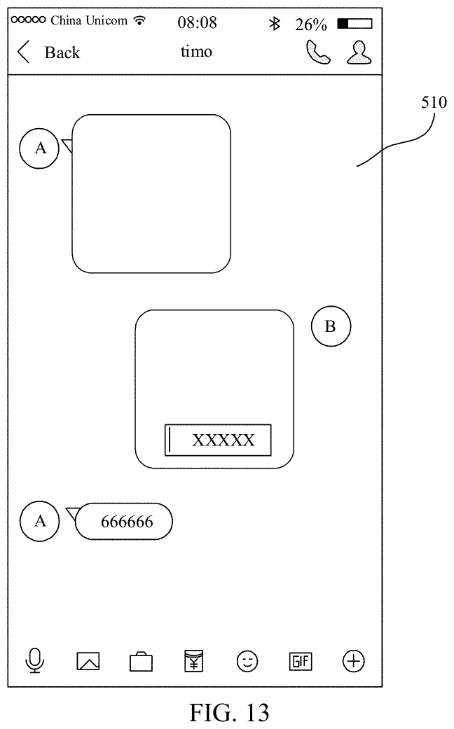

The self-made expression file configured in the application is generated by using the self-made expression image. In this case, the user may invoke the self-made expression file in the session window 510, to transmit the self-made expression file to the friend. FIG. 13 is a schematic diagram of a session window in which a self-made expression image is transmitted according to the embodiment corresponding to FIG. 12.

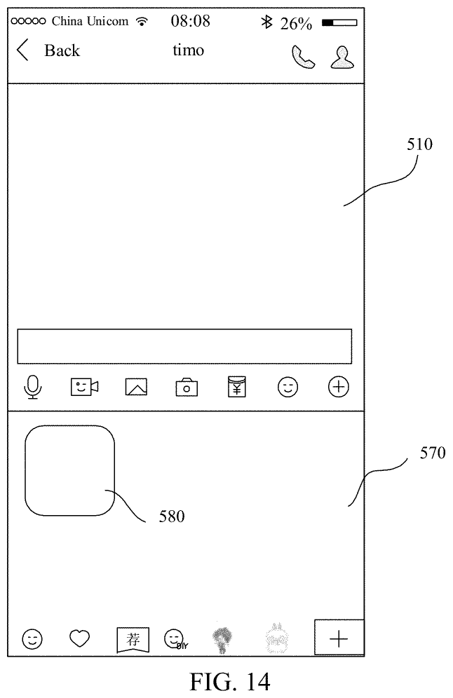

On the other hand, the self-made expression file configured in the application may be displayed on an expression panel 570 of the session window 510 in a thumbnail view, which refers to a thumbnail 580 shown in FIG. 14. FIG. 14 is a schematic diagram of displaying a self-made expression file in a thumbnail view in a session window according to the embodiment corresponding to FIG. 13.

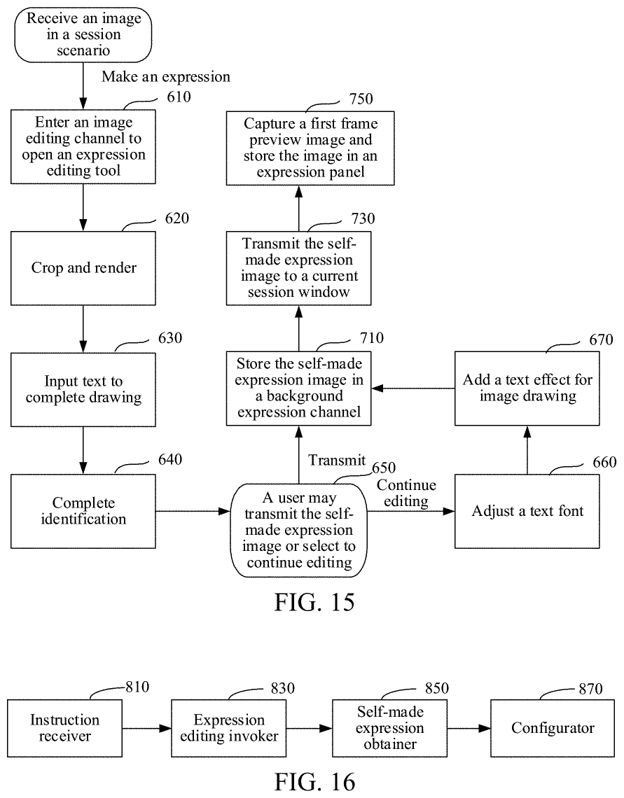

An implementation process related to the application scenario is shown in FIG. 15. FIG. 15 is a schematic flowchart of implementing a self-made expression image in an instant messaging tool according to an exemplary embodiment.

As shown in FIG. 15, in a session scenario implemented by using the instant messaging tool, if the image is received, expression making is triggered.

As shown in step 610, as the expression making is triggered, the instant messaging tool enters an image editing channel to open an expression editing tool. Under the action of the expression editing tool, processes shown in step 620 to step 640 may be performed to obtain a self-made expression image.

In this case, as shown in step 650, the user may transmit the self-made expression image or select to continue editing. On one hand, in the process of selecting to continue editing, the processes shown in step 660 to step 670 are performed.

Therefore, the self-made expression image is obtained in step 650 or step 670. That is, step 710 may be performed to store the self-made expression image in a background expression channel, to implement storing of the self-made expression image in the instant messaging tool, and complete configuration of the self-made expression image in the instant messaging tool.

Step 730 may be performed on the self-made expression image configured in the instant messaging tool to transmit the self-made expression image to a session window. On the other hand, step 750 may be performed to capture a first frame image of the self-made expression image that is displayed dynamically as a preview image to display the self-made expression image in a thumbnail view on an expression panel.

Therefore, the self-made expression image may be implemented based on an instant messaging relation chain, and may be spread to other scenarios while invoked in a session.

The following is an apparatus embodiment of the present disclosure, which may be used for executing the method embodiment for processing an image in an application in the present disclosure. For details that are not disclosed in this apparatus embodiment of the present disclosure, refer to the method embodiment for processing an image in an application in the present disclosure.

FIG. 16 is a block diagram of an apparatus for processing an image in an application according to another exemplary embodiment. As shown in FIG. 16, the apparatus for processing an image in an application may include but is not limited to: an instruction receiver 810, an expression file invoker 830, a self-made expression obtainer 850, and a configurator 870.

The instruction receiver 810 is configured to receive an expression file generating instruction corresponding to an image displayed in an application.

The expression editing invoker 830 is configured to invoke an expression editing tool built in the application according to the expression file generating instruction obtained after the image is triggered.

The self-made expression obtainer 850 is configured to obtain a self-made expression image corresponding to the image by using the expression editing tool and an expression editing operation triggered for the image.

The configurator 870 is configured to generate a self-made expression file that is configured in the application and that corresponds to the self-made expression image, the self-made expression image being invoked by the application to implement a self-configured specified function of the application.

In an exemplary embodiment, the application is a social networking application, and the image is an image received or transmitted in a session of the social networking application. The instruction receiver 810 is further configured to receive the expression file generating instruction corresponding to the image displayed in the social networking application in a session interface, of the social networking application, displaying the received and/or transmitted image. The self-made expression file generated by the expression file generating instruction for the displayed image is invoked by the social networking application to implement a function of transmitting an expression image in the session.

In another exemplary embodiment, the instruction receiver 810 is further configured to activate related action items of the displayed image in the application or the social networking application, and obtain the expression file generating instruction corresponding to the displayed image through triggering of selection of an expression making action item in the related action items.

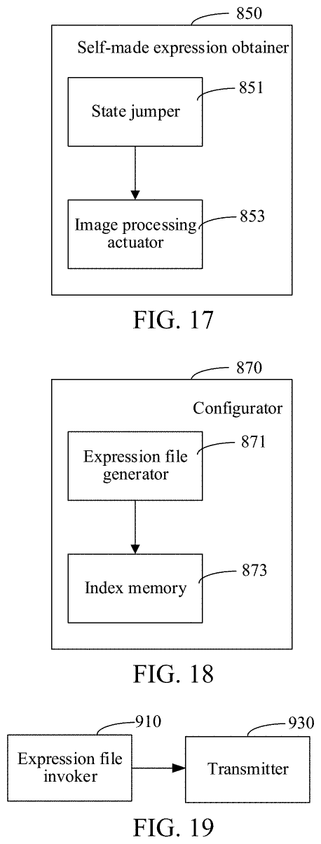

FIG. 17 is a block diagram for describing details of a self-made expression obtainer according to the embodiment corresponding to FIG. 16. As shown in FIG. 17, the self-made expression obtainer 850 may include but is not limited to: a state jumper 851 and an image processing actuator 853.

The state jumper 851 is configured to jump to an expression editing state corresponding to the displayed image by using the expression editing tool.

The image processing actuator 853 is configured to receive the expression editing operation triggered for the image in the expression editing state, and perform image processing corresponding to the expression editing operation on the image in the expression editing state by using the expression editing tool, to obtain the self-made expression image corresponding to the image.

FIG. 18 is a block diagram for describing details of a configurator according to the embodiment corresponding to FIG. 16. As shown in FIG. 18, the configurator 870 may include but is not limited to: an expression file generator 871 and an index memory 873.

The expression file generator 871 is configured to generate the self-made expression file corresponding to the self-made expression image.

The index memory 873 is configured to obtain a user identifier logged in the application, and store the self-made expression file in an application server and/or locally in the terminal device by using the user identifier as an index.

In an exemplary embodiment, the apparatus for processing an image in an application may further include but is not limited to: a panel display controller. The panel display controller is configured to display the self-made expression file in a thumbnail view on an expression panel of the application.

FIG. 19 is a block diagram of an apparatus for processing an image in an application according to another exemplary embodiment. As shown in FIG. 19, the apparatus for processing an image in an application may further include but is not limited to: an expression file invoker 910 and a transmitter 930.

The expression file invoker 910 is configured to select to invoke, according to a selection operation triggered for a thumbnail of a self-made expression file on an expression panel, an expression file indexed in the terminal device locally or in an application server by using a user identifier logged in an application and the thumbnail.

The transmitter 930 is configured to transmit the self-made expression file in the application.

Optionally, the present disclosure further provides a terminal device configured to perform all or some steps of the method for processing an image in an application shown in any one of FIG. 3, FIG. 4, FIG. 5, and FIG. 6. The terminal device includes:

a processor; and

a memory, storing computer-readable instructions, the computer-readable instructions, when executed by the processor, implementing the above method for processing an image in an application.

Optionally, the present disclosure further provides a computer-readable storage medium, storing a computer program. The computer program, when executed by a processor, implements the above method for processing an image in an application.

It can be understood that the present disclosure is not limited to the precise structures described above and shown in the accompanying drawings, and various modifications and changes can be made without departing from the scope of the present disclosure. The scope of the present disclosure is limited only by the appended claims.

What is claimed is:

1. A method for processing an image in a social networking application, performed by a terminal device having one or more processors and memory storing a plurality of programs to be executed by the one or more processors, the method comprising:
receiving an expression file generating instruction corresponding to an image displayed in an interface of the social networking application run by the terminal device;
invoking an expression editing tool built in the social networking application according to the expression file generating instruction obtained after the image is triggered;
obtaining a self-made expression image corresponding to the image by using the expression editing tool and an expression editing operation triggered for the image; and
generating, in the interface of the social networking application, a self-made expression file that is configured in the social networking application and that corresponds to the self-made expression image, the self-made expression file being invoked by the social networking application to implement a self-configured specified function of the social networking application, and the specified function being different from an expression making function.

2. The method according to claim 1, wherein the image is an image received or transmitted in a session of the social networking application, and the receiving an expression file generating instruction corresponding to an image displayed in an application comprises:
receiving the expression file generating instruction corresponding to the image displayed in the social networking application in a session interface, of the social networking application, displaying the received and/or transmitted image, the self-made expression file generated by the expression file generating instruction for the displayed image being invoked by the social networking application to implement a function of transmitting an expression image in the session.

3. The method according to claim 1, wherein the receiving the expression file generating instruction corresponding to the image displayed in the application or the social networking application comprises:
activating related action items of the displayed image in the application or the social networking application, and obtaining the expression file generating instruction corresponding to the displayed image through triggering of selection of an expression making action item in the related action items.

4. The method according to claim 1, wherein the obtaining a self-made expression image corresponding to the image by using the expression editing tool and an expression editing operation triggered for the image comprises:
jumping to an expression editing state corresponding to the displayed image by using the expression editing tool;
receiving the expression editing operation triggered for the image in the expression editing state; and
performing image processing corresponding to the expression editing operation on the image in the expression editing state by using the expression editing tool, to obtain the self-made expression image corresponding to the image.

5. The method according to claim 1, wherein the generating, in the interface of the social networking application, a self-made expression file that is configured in the social networking application and that corresponds to the self-made expression image comprises:
generating the self-made expression file corresponding to the self-made expression image;
obtaining a user identifier logged in the social networking application; and
storing the self-made expression file in an application server and/or locally in the terminal device by using the user identifier as an index.

6. The method according to claim 1, wherein the method further comprises:
after generating, in the interface of the social networking application, a self-made expression file that is configured in the application and that corresponds to the self-made expression image, displaying the self-made expression file in a thumbnail view on an expression panel of the social networking application.

7. The method according to claim 6, wherein a thumbnail of the self-made expression file is associated with the expression file, and after the displaying the self-made expression file in a thumbnail view on an expression panel of the application, the method further comprises:
selecting to invoke, according to a selection operation triggered for the thumbnail of the self-made expression file on the expression panel, the expression file indexed in the terminal device locally or in the social networking application server by using the user identifier logged in the application and the thumbnail; and
transmitting the self-made expression file in the social networking application.

8. A terminal device for processing an image in a social networking application, the terminal device comprising one or more processors, memory coupled to the one or more processors and a plurality of programs stored in the memory that, when executed by the one or more processors, cause the terminal device to perform a plurality of operations comprising:
receiving an expression file generating instruction corresponding to an image displayed in an interface of the social networking application run by the terminal device;
invoking an expression editing tool built in the social networking application according to the expression file generating instruction obtained after the image is triggered;
obtaining a self-made expression image corresponding to the image by using the expression editing tool and an expression editing operation triggered for the image; and
generating, in the interface of the social networking application, a self-made expression file that is configured in the social networking application and that corresponds to the self-made expression image, the self-made expression file being invoked by the social networking application to implement a self-configured specified function of the social networking application, and the specified function being different from an expression making function.

9. The terminal device according to claim 8, wherein the image is an image received or transmitted in a session of the social networking application, and the receiving an expression file generating instruction corresponding to an image displayed in an application comprises:
receiving the expression file generating instruction corresponding to the image displayed in the social networking application in a session interface, of the social networking application, displaying the received and/or transmitted image, the self-made expression file generated by the expression file generating instruction for the displayed image being invoked by the social networking application to implement a function of transmitting an expression image in the session.

10. The terminal device according to claim 8, wherein the receiving the expression file generating instruction corresponding to the image displayed in the application or the social networking application comprises:
activating related action items of the displayed image in the application or the social networking application, and obtaining the expression file generating instruction corresponding to the displayed image through triggering of selection of an expression making action item in the related action items.

11. The terminal device according to claim 8, wherein the obtaining a self-made expression image corresponding to the image by using the expression editing tool and an expression editing operation triggered for the image comprises:
jumping to an expression editing state corresponding to the displayed image by using the expression editing tool;
receiving the expression editing operation triggered for the image in the expression editing state; and
performing image processing corresponding to the expression editing operation on the image in the expression editing state by using the expression editing tool, to obtain the self-made expression image corresponding to the image.

12. The terminal device according to claim 8, wherein the generating, in the interface of the social networking application, a self-made expression file that is configured in the social networking application and that corresponds to the self-made expression image comprises:
generating the self-made expression file corresponding to the self-made expression image;
obtaining a user identifier logged in the social networking application; and
storing the self-made expression file in an application server and/or locally in the terminal device by using the user identifier as an index.

13. The terminal device according to claim 8, wherein the plurality of operations further comprise:
after generating, in the interface of the social networking application, a self-made expression file that is configured in the application and that corresponds to the self-made expression image, displaying the self-made expression file in a thumbnail view on an expression panel of the social networking application.

14. The terminal device according to claim 13, wherein a thumbnail of the self-made expression file is associated with the expression file, and after the displaying the self-made expression file in a thumbnail view on an expression panel of the application, the plurality of operations further comprise:
selecting to invoke, according to a selection operation triggered for the thumbnail of the self-made expression file on the expression panel, the expression file indexed in the terminal device locally or in the social networking application server by using the user identifier logged in the application and the thumbnail; and
transmitting the self-made expression file in the social networking application.

15. A non-transitory computer readable storage medium storing a plurality of machine readable instructions in connection with a terminal device having one or more processors for processing an image in a social networking application, wherein the plurality of machine readable instructions, when executed by the one or more processors, cause the terminal device to perform a plurality of operations including:
receiving an expression file generating instruction corresponding to an image displayed in an interface of the social networking application run by the terminal device;
invoking an expression editing tool built in the social networking application according to the expression file generating instruction obtained after the image is triggered;
obtaining a self-made expression image corresponding to the image by using the expression editing tool and an expression editing operation triggered for the image; and
generating, in the interface of the social networking application, a self-made expression file that is configured in the social networking application and that corresponds to the self-made expression image, the self-made expression file being invoked by the social networking application to implement a self-configured specified function of the social networking application, and the specified function being different from an expression making function.

16. The non-transitory computer readable storage medium according to claim 15, wherein the image is an image received or transmitted in a session of the social networking application, and the receiving an expression file generating instruction corresponding to an image displayed in an application comprises:
receiving the expression file generating instruction corresponding to the image displayed in the social networking application in a session interface, of the social networking application, displaying the received and/or transmitted image, the self-made expression file generated by the expression file generating instruction for the displayed image being invoked by the social networking application to implement a function of transmitting an expression image in the session.

17. The non-transitory computer readable storage medium according to claim 15, wherein the receiving the expression file generating instruction corresponding to the image displayed in the application or the social networking application comprises:
activating related action items of the displayed image in the application or the social networking application, and obtaining the expression file generating instruction corresponding to the displayed image through triggering of selection of an expression making action item in the related action items.

18. The non-transitory computer readable storage medium according to claim 15, wherein the obtaining a self-made expression image corresponding to the image by using the expression editing tool and an expression editing operation triggered for the image comprises:
jumping to an expression editing state corresponding to the displayed image by using the expression editing tool;
receiving the expression editing operation triggered for the image in the expression editing state; and
performing image processing corresponding to the expression editing operation on the image in the expression editing state by using the expression editing tool, to obtain the self-made expression image corresponding to the image.

19. The non-transitory computer readable storage medium according to claim 15, wherein the generating, in the interface of the social networking application, a self-made expression file that is configured in the social networking application and that corresponds to the self-made expression image comprises:
generating the self-made expression file corresponding to the self-made expression image;
obtaining a user identifier logged in the social networking application; and
storing the self-made expression file in an application server and/or locally in the terminal device by using the user identifier as an index.

20. The non-transitory computer readable storage medium according to claim 15, wherein the plurality of operations further comprise:
after generating, in the interface of the social networking application, a self-made expression file that is configured in the application and that corresponds to the self-made expression image, displaying the self-made expression file in a thumbnail view on an expression panel of the social networking application.
